(19) United States
(12) Patent Application Publication
(10) Pub. No.: US 2008/0116126 A1
(43) Pub. Date: May 22, 2008

(54) Liquid Filter With Contamination-Protected Clean Side

(76) Inventors: Achim Greiving, Duelmen (DE); Richard Eberle, Muenster (DE)

Correspondence Address: BOHAN, MATHERS & ASSOCIATES, LLC, PO BOX 17707, PORTLAND, ME, 04112-8707, US

(21) Appl. No.: 11/941,248

(22) Filed: Nov. 16, 2007

(30) Foreign Application Priority Data
Nov. 16, 2006 (DE) 20 2006 017 614.4

(51) Int. Cl. B01D 35/30

(52) U.S. Cl. 210/167.08; 210/232

(57) ABSTRACT

A liquid filter for use as an oil filter or a fuel filter, having a filter insert supported on a support tower. The support tower is essentially a cylindrical tube, with passage openings that provide a flowpath from outside the tower to a space inside the tower. A circumferential wiping lip and a circumferential seal are provided on the lower end of the filter insert. When the insert is assembled onto the support tower, the wiping lip first wipes the wall of the tower clean and the seal then seals the lower end of the tower against an unfiltered space. The seal and wiping lip may be combined as a single component.

### BACKGROUND INFORMATION

1. Field of the Invention

The invention relates to a liquid filter for an internal combustion engine. More particularly, the invention relates to a liquid filter that has a support tower for supporting the filter medium, the support tower being fixedly mounted on the filter housing.

2. Description of the Prior Art

Such liquid filters are known from the automotive engineering sector. The essentially tubular support tower serves to prevent the filter medium of the filter insert from collapsing under the prevailing temperature and pressure conditions during filter operation. Liquid filters are used, for example, as fuel or oil filters, whereby conventional liquid filters are constructed differently, depending upon the their application as either fuel or oil filters.

The demand is for the most reliable separation possible between the filtered and unfiltered sides of the filter. Different surfaces of the filter may lie on the unfiltered, or the filtered side of the filter, depending upon the arrangement of inflow and outflow ports for the liquid to be filtered. The support tower is located on the filtered side of the filter in the typical construction of the conventional filter used in the industry. The filtering surface of the filter medium forms a barrier that separates the unfiltered side of the filter from the filtered side during filter operation. The filter medium may be constructed, for example, as a pleated paper filter, so that the filtering surface is a porous paper material. Increasing precision in the construction of fuel injection systems also increases the demands on the fuel, particularly with respect to its purity. For example, even slight contamination of the fuel can pose a significant problem, since, for example, dirt particles can block the fine nozzle channels of the injection system or water can corrode the sensitive materials used inside the injection system. Appropriate selection of the filtering paper material can ensure the desired separation of unfiltered and filtered sides during filter operation.

It is possible, however, particularly during a so-called filter change, that is, when replacing the filter insert, that contaminants reach the filtered side from the unfiltered side. Particularly, there is the risk that contaminants from the area of the engine compartment can get into the opened filter, that is, into the filter housing and be deposited on the filtered side of the filter, for example, on the support tower.

Other contaminants that can get into the inner area of the filter housing end up for the most part on the surfaces, which later, that is, after the filter insert is installed, are on the unfiltered side of the filter. These contaminants are not critical, because the filter medium will hold them during filter operation.

The object of the invention is to improve the conventional liquid filter in such a way that the filter offers the best protection possible of the filtered side against contamination that can occur during filter service.

### BRIEF SUMMARY OF THE INVENTION

This object is achieved by providing a liquid filter that has a housing enclosing by a hollow space, with a removable lid for closing the housing. An exchangeable filter element is arranged in the housing. This filter element has a ring-shaped cross-section and a filter medium for filtering liquid. A support tower that prevents the filter medium from collapsing is fixedly arranged in the housing and extends into the hollow space. The support tower is constructed essentially as a cylindrical tube. Passage openings in the support tower provide a flow path from outside the support tower into an inner central space of the support tower. The filter element has a lower end that projects deepest into the housing. A circumferential seal and a circumferential wiping lip are provided on the lower end of the filter elements. Both the seal and the wiping lip extend radially inward and fit up against the support tower.

In other words, the filter according to the invention provides protection against contamination at two sites: On the one hand, contaminants can occur along the support tower, that is, on the outer surface area of an basically approximately cylindrical support tower. According to a first embodiment of the invention, the combination of wiping lip and seal provides a cleaning process that wipes these contaminants off of the support tower when the filter insert is installed and pushed down along the support tower. The contaminants are thereby pushed farther into the inside of the filter on the support tower, that is, onto the unfiltered side of the filter. When the filter insert has been completely assembled on the support tower, clean, filtered liquid moves radially from the outside of the filter insert, all the way through the filter medium to the support tower, and reaches the outer surface area of the support tower. The cleaning process during assembly of the filter insert ensures that this liquid cannot now transport any contaminants into the inside of the support tower. When the liquid filter according to the invention is constructed as a fuel filter, for example, the cleaning process prevents particles from penetrating into a fuel injection system; when constructed as an oil filter, it prevents particles from getting into the fine boreholes that serve as the oil channels.

Although contaminants are still found in the filter, they are on the unfiltered side, outside of the filter insert, where they either remain or are entrained by the flow of the liquid and carried to the outside of the filter medium, which holds them back.

In order to ensure reliable cleaning of the support tower, the support tower in the liquid filter according to the invention has a cylindrical, smooth-walled outer surface. A ribbed surface structure of the support tower would sufficiently provide the support function for the filter insert. Nevertheless, a smooth-walled construction according to the invention is suggested, so as to prevent initially removed impurities from settling into depressions on the outside of the support tower, where they would be beyond the reach of the wiping lip of the filter insert. Within the framework of the present embodiment, a support tower surface is termed smooth-walled, if it allows the wiping lip to circumferentially fit up against the outer surface of the support tower as it travels along the support tower, thus guaranteeing the desired wiping effect. The surface of the support tower can therefore have a certain waviness and does not necessarily have to be a strictly cylindrical construction.

In practice, conventional filters are mounted in the most diverse installation positions. Within the framework of the present embodiment, however, “above” and “below” refer to an orientation that, merely as an example, assumes that the filter housing has a vertical center axis and that the filter cover is located above.

According to the invention, the wiping lip is arranged below the seal that is provided on the filter insert. Thus, the wiping lip is guided over the support tower before the seal reaches the same place on the support tower. This ensures, first of all, that the seal can optimally fit up against the support tower, since there are no impurities on the support tower in the area where the seal fits. Secondly, this guarantees advantageously that the entire area of the support tower belonging to the filtered side of the filter during filter operation has a cleaned surface, since the wiping lip is arranged in front of the seal in the assembly direction of the filter insert and, when the filter insert is installed, the seal separates the unfiltered side from the filtered side.

A cylindrical construction of the support tower ensures that the wiping lip can reliably remove contaminants that are stuck on the surface of the support tower along the entire path over which the wiping lip is guided during the assembly of the filter insert on the support tower. Within the framework of the present embodiment, “cylindrical” should not be understood as geometrically precisely cylindrical, but rather the support tower may be designed with a slightly conical or wavy surface. For example, the support tower may be tapered in order to facilitate its release from the mold during the manufacture of the support tower. In this case, however, under practical considerations, the different diameters along the entire length of the support tower should differ so little from each other that the cleaning function of the wiping lip during filter insert assembly may be reliably guaranteed. With respect to the cross-sectional geometry of the support tower, deviations from a precisely circular embodiment may also be implemented, for example, the support tower may have an oval profile. The circular shape that would, however, be connected to the cylindrical construction of the support tower is advantageous, inasmuch as it enables the wiping lip to exert a uniform circumferential contact pressure against the support tower and thus ensures uniform cleaning results along the entire periphery of the support tower.

The aforementioned construction of the support tower surface, which deviates from an ideal cylinder, may advantageously have a surface profile with some protrusions. Under the prevailing temperature and pressure conditions during filter operation, one can assume that the filter medium lies up against the support tower, specifically against these aforementioned protrusions. Between the protrusions, areas are thus created where the filter medium does not lie up against the surface of the support tower. Liquid that has passed radially inward through the filter medium and is now filtered and clean, therefore finds flow paths between the protrusions through which it can flow to a port or an opening, whereby the port leads to the inside of the support tower.

When the filter insert is pushed onto the support tower, it is advantageous to be careful with the seal of the filter insert and protect it from damage. Advantageously, the outer circumference of the support tower in seal area where the filter insert seal contacts or fits up against the support tower may have a circumference or an external diameter that is greater than the rest of the support tower. Thus, if the diameter of the seal area is designed for optimal fit of the seal, then, the diameter of the support tower above this seal area will be smaller than that of the seal area. The seal of the filter insert therefore does not scrape along the surface of the support tower with an undesirably high pressure, when the filter insert is installed. The greater diameter in the seal area, however, guarantees the desired seal-tight fit of the seal on the support tower.

A second area in which contaminants can occur, which then possibly reach the filtered side of the filter, is via the upper face of the support tower. Depending upon the construction of the filter and the filter insert, this upper face of the support tower may lie on the filtered side of the filter. In order to prevent contaminants that have settled on this upper face of the support tower from being transported by the filtered, clean liquid into the inside of the support tower, and, from there, for example, to the supply sites of the engine, the upper end plate of the filter insert has a seal-tight fit, so that these types of contaminants are unable to escape the face of the support tower, and instead remain there.

An advantageous filter insert has, for example, on its lower end plate or adjacent to this end plate, that is, on its lower end, a circumferential wiping lip that contacts or fits up against the support tower of the filter as described above. Placing the wiping lip as far down as possible on the filter insert enables a space-saving design for the filter insert. This enhances the most compact possible construction for the entire filter, so that it may be installed even under crowded assembly conditions, for example, in an engine compartment of an automobile. The lower end of the filter insert is initially guided into the filter housing and onto the support tower, which enables reliable cleaning of contaminants found on the outer surface area of the support tower.

This wiping lip can be constructed as an extension of the lower end plate. For example, the lip may be made from the same material as that of the lower end plate and be constructed as a relatively thin-walled wiping lip, in contrast to the correspondingly thicker construction of the lower end plate. This construction avoids the costs for a second component and its assembly.

Alternatively, the wiping lip may advantageously be made of an elastomeric or foam material, so as to ensure a reliable seal of the support tower throughout the entire service life of the filter insert. Material relaxation, due to the effects of temperature, pressure or age, may be excluded by selecting the appropriate material. Due to its compressibility, a foam material, for example, makes it possible to bridge comparatively large differences in diameter, so that, for example, it is even possible for the foam lip to clean a profiled support tower, namely, to clean both the protrusions and the areas therebetween.

The wiping lip, if made of a different material than the lower end plate, may be molded onto or adhesively affixed to the lower end plate. Alternatively, the wiping lip may be provided with its own retainer, which itself is connected to the filter insert. Thus, for example, a ring-shaped retainer may be provided which is made of a material that is particularly reliable or that can be connected especially inexpensively to the lower end plate of the filter insert, so that this retainer ensures the reliable contact or fit of the wiping lip in its designated location.

Advantageously, the wiping lip may extend radially inward farther than the seal of the filter insert, which ensures reliable cleaning of the support tower. This also applies to those places where the support tower has a smaller diameter than in the seal area where the seal of the assembled filter insert contacts or fits up against the support tower.

A particularly compact construction of the filter insert is possible, if the seal and the wiping lip are constructed as a common combined component.

Advantageously, such a combined component can be made of a single material, that is, made completely of the same material. This means that this combined-component can be produced particularly economically. Furthermore, the space-saving filter insert may be particularly compact in construction, since two different components, namely, the wiping lip and the seal, do not have to be assembled axially behind one another. Rather, only the space for the seal must be provided, and the wiping lip can extend as a section of the combination component from the seal section of this combined component.

Alternatively, however, this combined component may be made of at least two different materials. For example, a basic material may be used to form the seal and a second material, which exhibits optimal cleaning properties and, for example, a particularly high stretchability, may be used to form the wiping lip.

For example, the combined component made of two materials may be designed as a so-called two-component part, as is known, for example, in everyday life, for example, in toothbrushes, whose handles have a comparably harder first component, as well as some areas made from a relatively softer second component. Thus, for the combined component, the first component may, for example, form the seal, and the second component the wiping lip.

The seal in the upper area of the support tower may advantageously be such that the upper end plate is sealed directly against the tubular body of the support tower. Thus, apart from the seal itself, no additional intermediate components need be provided. In this case, too, manufacture of the liquid filter is particularly economical, because manufacturing and assembly costs are avoided.

Alternatively, an aforementioned intermediate component may be provided, whereby this intermediate component is fixedly connected to either the filter insert or the support tower and the seal contacts or fits up against this intermediate component. Depending upon the construction of the filter, such an intermediate component enables implementation of complicated geometries, or easily allows implementation of additional functions in the area of the upper end of the support tower.

The upper end of the support tower may advantageously be covered by a cap that not only enables a closing of the tubular support tower, but also contains an additional functional element. Such a functional element can, for example, be provided as a vent, if, for example, the liquid filter is constructed to be a fuel filter. Alternatively, this functional element may be constructed as the filter bypass valve of an oil filter, which opens at a set pressure in a known manner in order to create a flowpath connection from the unfiltered side to the filtered side of the filter. This is desirable, for example, if the filter medium is clogged or if the oil has a high viscosity caused by temperature, and, as a result, only insufficient amounts of oil, which are needed for supplying all lubricating points, are flowing through the filter.

The aforementioned cap may advantageously be constructed as part of the upper end plate of the filter insert, which allows the elimination of an additional component.

Alternatively, the cap may advantageously be constructed as an additional component which is arranged in the upper end of the tubular body of the support tower. This ensures that, following disassembly of the filter insert, the support tower is not open on the face side. In this state, the cap reliably prevents contaminants from penetrating into the support tower, since the cap remains fixedly attached to the filter, namely, arranged on the support tower.

When the liquid filter is constructed as a fuel filter, it may advantageously have a conventional fuel-tank runback. On the one hand, this makes a high fuel pump performance possible, which, under certain operating conditions of the engine, causes a surplus of the delivered fuel to be returned to the tank. Furthermore, contaminants may be removed from inside of the filter housing in this way, namely, carried back to the fuel tank, where they can settle out of the fuel.

### BRIEF DESCRIPTION OF THE DRAWINGS

Using the purely schematic drawings, embodiments of the innovation are explained in more detail below. Shown are:

FIG. 1 is a longitudinal cross-sectional view of a first embodiment of the liquid filter according to the invention.

FIG. 2 is an enlarged illustration of the lower end of the support tower shown in FIG. 1.

FIG. 3 longitudinal cross-sectional view of a second embodiment of the filter according to the invention.

FIG. 4 is an enlarged illustration of the lower end of the support tower shown in FIG. 3.

FIG. 5 longitudinal cross-sectional view of a third embodiment of the filter according to the invention.

FIG. 6 is a partial cross-sectional view of a first embodiment of the closing member on the upper end plate.

FIG. 6a is a partial cross-sectional view of a further embodiment of the closing member on the upper end plate.

FIG. 7 is a partial cross-sectional view of a further embodiment of the closing member on the upper end plate.

FIG. 8 is a partial cross-sectional view of a further embodiment of the closing member secured in the upper end of the support tower.

FIG. 9 is a partial cross-sectional view of a seal provided by the upper end plate against the closing member.

FIG. 10 is a partial cross-sectional view illustrating a bypass valve in the closing member.

FIG. 11 is a longitudinal cross-sectional view of the filter according to the invention, showing various seals.

FIG. 12 is a perspective view of a generally tubular-shaped support tower having a wavy outer surface.

FIG. 13 is a perspective view, turned 90 degrees relative to the view of FIG. 12, showing the passage opening into inner space enclosed by the support tower.

FIG. 14 is a longitudinal cross-sectional view, illustrating a support tower with a wavy outer surface and the flow path created by the passage openings.

FIG. 15 is an assembly drawing, partially in a cross-sectional view, showing a support tower with a wavy outer surface and a wiping lip of compressible material.

FIG. 16 shows a first embodiment of a combination seal/wiper component.

FIG. 17 shows a second embodiment of a combination seal/wiper component.

FIG. 18 shows a third embodiment of a combination seal/wiper component.

FIG. 19 shows a fourth embodiment of a combination seal/wiper component.

### DETAILED DESCRIPTION OF THE INVENTION

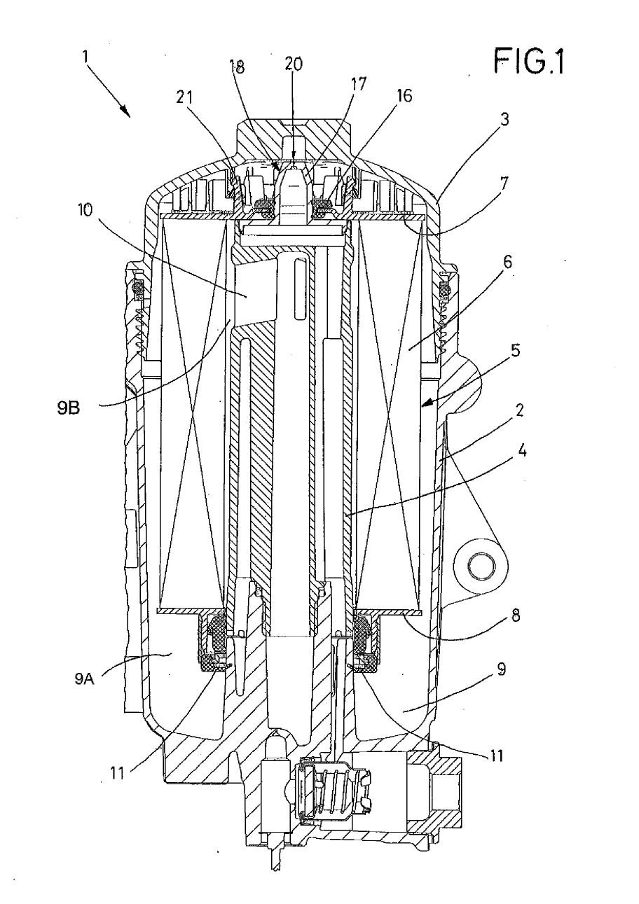

FIG. 1 illustrates generally a liquid filter 1 that has a housing 2 and a screw-off lid 3. Fixedly connected to the housing 2 inside the liquid filter 1 is a support tower 4 that extends into the inner recess of a filter insert 5. A filter medium 6 of the filter insert is a pleated paper filter, which is arranged between an upper end plate 7 and a lower end plate 8 of the filter insert 5. This filter medium 6 divides an interior space 9 of the filter 1 into an interior unfiltered space 9A and an interior filtered space 9B.

This embodiment of the liquid filter 1 is a fuel filter. The unfiltered liquid is fed into the interior 9, into the unfiltered interior space 9A of the housing 2 and reaches the outside of the filter insert 5. The unfiltered liquid flows through the filter medium 6 and, in this way, now filtered, reaches the interior filtered space 9B inside of the filter insert 5. From there, the filtered liquid travels upward in the folds of the filter insert 5, along the support tower 4, where it reaches passage openings or through-ports 10 and, in this way, flows into an internal clean area 4A inside the support tower 4, which leads to the outflow port of the liquid filter 1.

The support tower 4 has a smooth exterior wall and is constructed as a cylinder, with a wiping lip 11 provided in the area of the lower end plate 8. The wiping lip 11 scrapes contaminants downward on the outer surface of the support tower 4, during installation of the filter insert 5, thus cleaning the support tower 4. In the drawing, the contours of each of the different seals are shown in their undeformed state, in order to better illustrate the dimensions of the respective seal components.

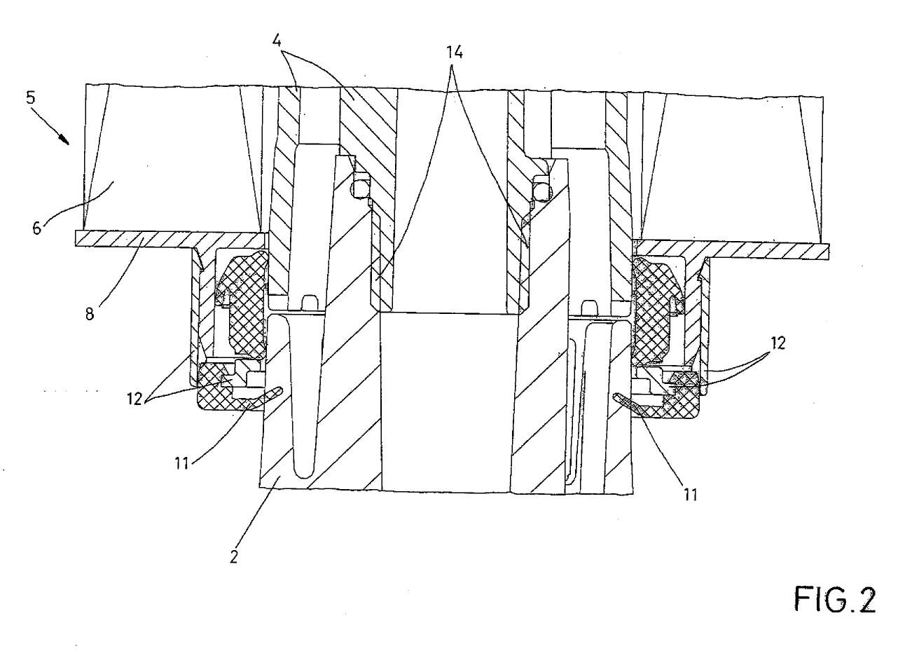

FIG. 2 shows the lower area of the filter insert 51 enlarged relative to FIG. 1. Clearly visible is a retainer 12 that is clipped onto the lower end plate 8 and that supports the wiping lip 11. The support tower 4 has a threaded opening that screws onto the housing 2 of the filter by means of threads 14 and, thus, remains fastened to the housing 2 of the filter 1 when the filter insert 5 is changed.

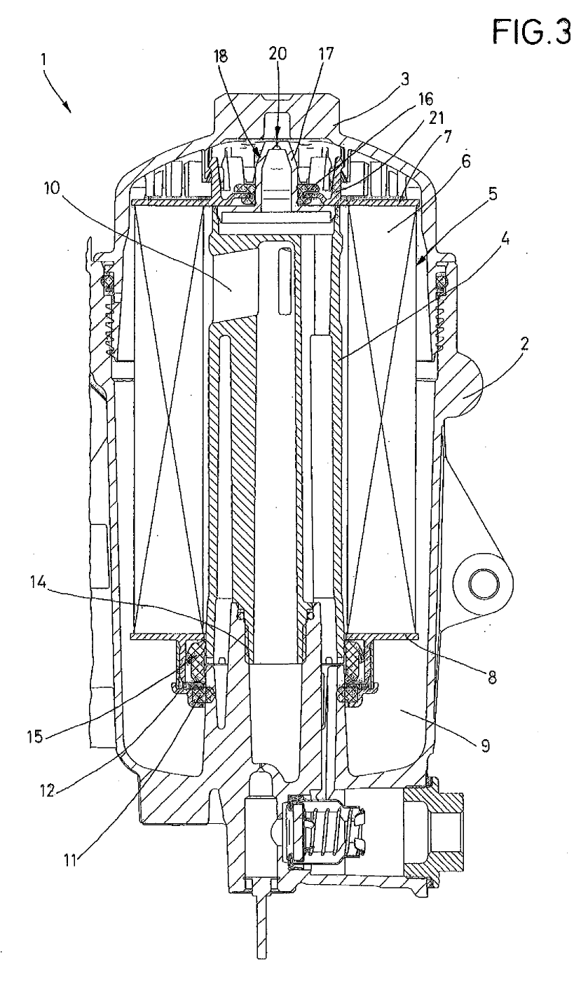

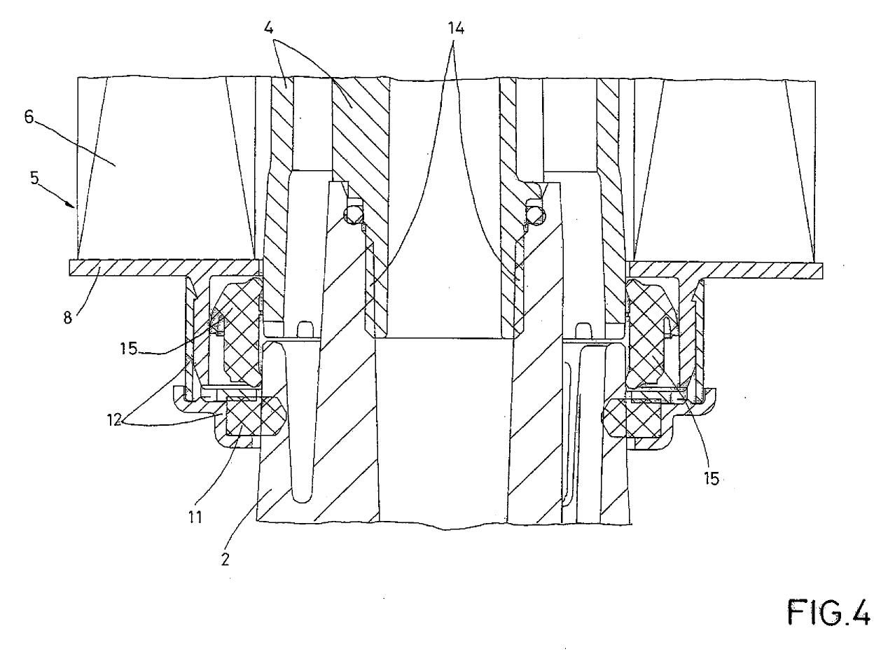

The wiping lip 11 shown in FIGS. 1 and 2 is a profile seal. By contrast, the embodiment shown in FIGS. 3 and 4 depicts a wiping lip 11 made of foam material, which accordingly has a somewhat more compact cross-sectional profile. Similar to the embodiment in FIGS. 1 and 2, a combination seal 15 is provided in addition to the wiping lip 11 that is always provided. The combination seal 15 provides a seal between the housing 2 and the support tower 4 on the one hand, and, on the other hand, provides a reliable seal between the radial external unfiltered side 9A and the radial clean or filtered side 9B of the liquid filter 1. Because of the presence of this combination seal 15, the wiping lip 11, in contrast to the embodiments of FIGS. 1 and 4, may also be made of a relatively hard or stiff material, for example, may be made from the material that is also used for the lower end plate 8. Thus, the lower wiping lip 11 may be made of the same material as the lower end plate 8 or of the retainer 12. In this case, the retainer 12 does not actually serve as a retainer for the additional wiping lip 11, but rather itself forms the wiping lip with a correspondingly thin-walled section. This relatively hard material may relax during the operation of the liquid filter. It is, however, not necessary that the wiping lip 11 provide a sealing effect during filter operation. Rather, the liquid filter according to the invention cleans the support tower 4 of contaminants that have settled onto it only when the filter insert 5 is inserted into the liquid filter 1. It is the combination seal 15 that fulfills the subsequent sealing task between the unfiltered and filtered sides during filter operation.

The examples of the embodiments shown in FIGS. 1-4 show a seal 16 at the upper end plate 7 of the filter insert 5, with the seal 16 fitting up against a connecting piece 17 of an upper cap 18. FIG. 5 shows an embodiment in which a profile seal 19 provides a seal directly between the upper end plate 7 and the cylindrical body of the support tower 4. The site where the cap 18 fits against the support tower 4 is located inside the support tower 4, and, because of this, contaminants that are present around the connecting piece 17 on the ring-shaped surface of the cap 18 are on the unfiltered side of the filter when a new filter insert 5 is installed and sealed with its profile seal 19 against the support tower 4. This relocation of the site where the cap 18 fits against the support tower 4 can be achieved by making the support tower 4 higher than the one shown in the embodiments of FIG. 1-4, or by using a cap 18 that extends deep enough into the support tower 4.

In all previously described embodiments, the cap 18 contains a functional component in the form of a vent 20.

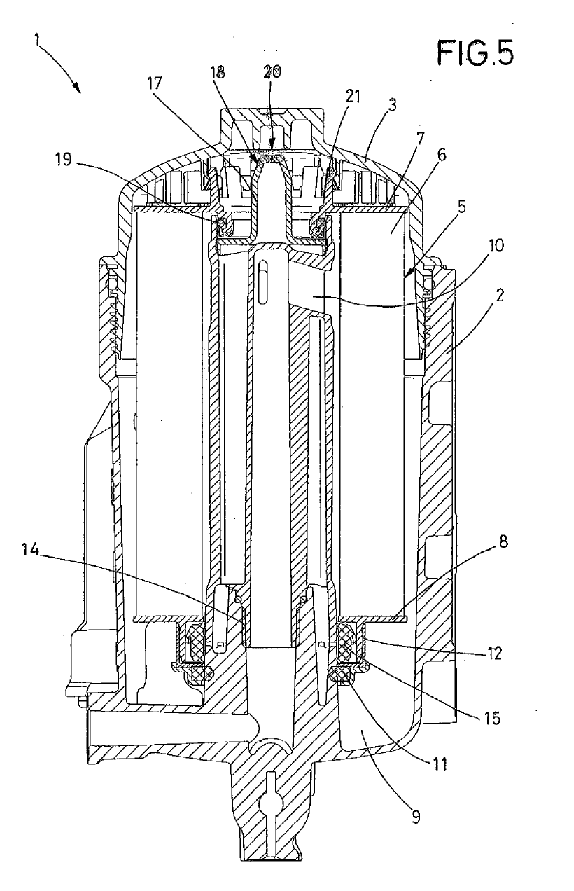

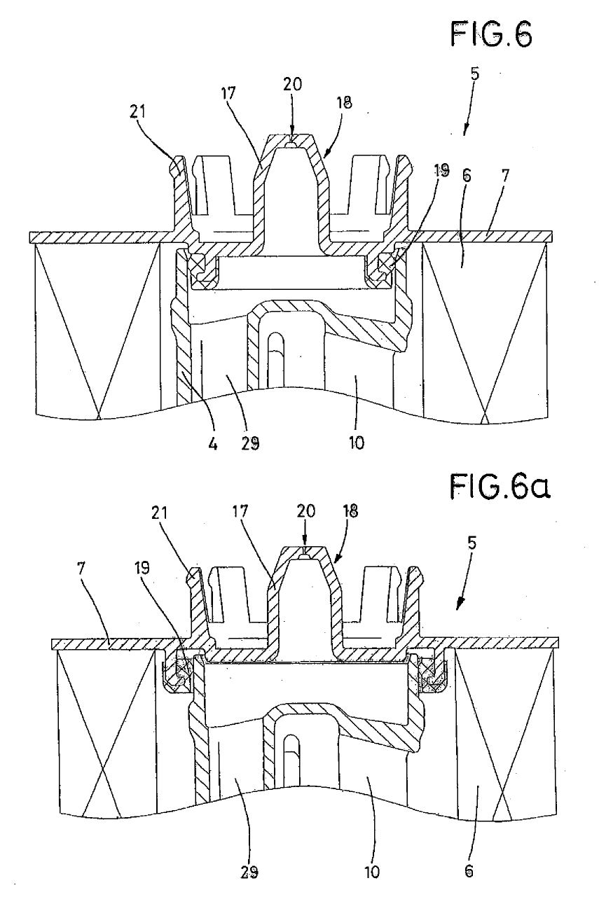

FIG. 6 is a partial cross-sectional illustration, showing an enlarged view of the area around the cap 18. This embodiment the cap 18 is a particularly advantageous construction that is made of the same material as the upper end plate 7 of the filter insert 5. A first possibility of contaminants getting into the inside of the housing 2 occurs when replacing the filter, that is, when replacing the filter insert 5. These contaminants are found on the floor or on the inside wall of the housing and, thus, on the unfiltered side of the filter. This is not critical, because after the installation of a new filter insert 5, these contaminants are held back during the normal filtering process and do not reach the filtered side of the filter.

The second possibility is that particles may reach the outside of the support tower 4. In this case, they are scraped off by the aforementioned wiping lip 11 during installation of a new filter insert 5 and are thereby kept on the unfiltered side of the filter, where they are not critical.

The third possibility-is when particles may get into the support tower 4 that is open at the top and, thus, into a tank runback 29. This fuel tank runback 29 allows filtered, excess fuel, for example, fuel that is not needed by the injection system of a combustible engine, to flow back into the fuel tank. The particles then either settle out in the tank or are transported again from there with the fuel to the liquid filter 1, namely, to its unfiltered side, and are subsequently held back by the filter medium 6 of the filter insert 5, within the framework of the normal filtration process.

The embodiment shown in FIG. 6 shows a profile seal 19 on the upper end plate 7 of the filter insert 5 that fits up against the inside of the cylindrical body of the support tower 4. The vent 20 is also formed by the cap 18 and, thus, by the upper end plate 7 of the filter insert 5, as are latching clips 21, with which the filter insert 5 may be fastened to the lid 3, so that the lid 3 may be removed from the housing 2 of the liquid filter 1 together with the filter insert 5.

FIG. 6a shows a variant of the embodiment of FIG. 6 in which the profile seal 19 fits up against the outside of the support tower 4. This means that, advantageously, the upper, narrow, ring-shaped face surface of the support tower 4 is still part of the unfiltered side of the liquid filter 1 after the filter insert 5 is assembled, so it is also not critical if any particles reach this narrow face surface of the support tower 4.

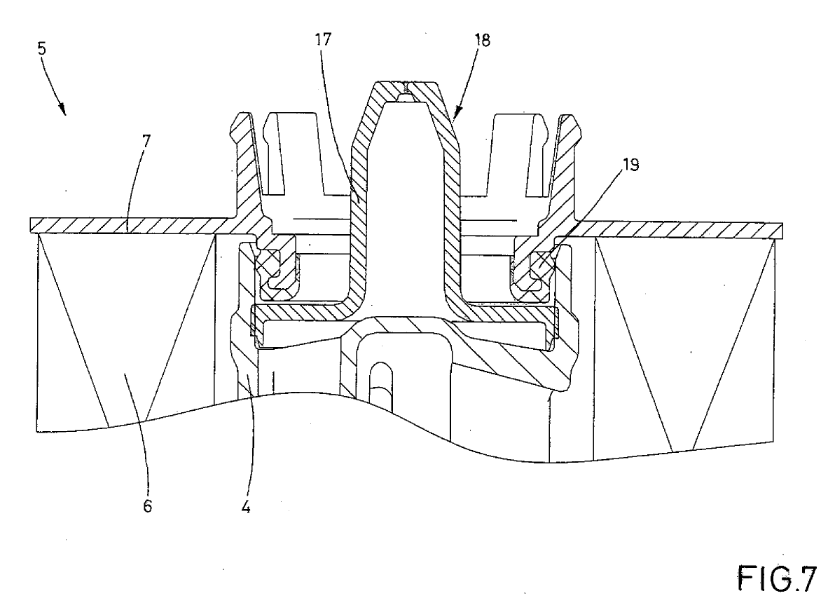

FIG. 7 shows a cap 18 that is constructed as an independent component and is fixedly attached to the support tower 4 by a threaded fastening, welding, or similar fixed fastening methods. Contaminants that are able to reach the inside of the liquid filter 1 and the surface of the cap 18 when changing the filter are uncritical, inasmuch as a profile seal 19 tightly seals the cylindrical body of the support tower 4 when the filter insert 5 is completely inserted into the liquid filter 1. Since the cylindrical body of the support tower 4 is drawn up higher than the surface of the cap 18 outside of the connecting piece 17, enough space is provided there to achieve the desired seal between the upper end plate 7 and the support tower 4, so that all contaminants found on the cap 18 remain on the unfiltered side of the liquid filter.

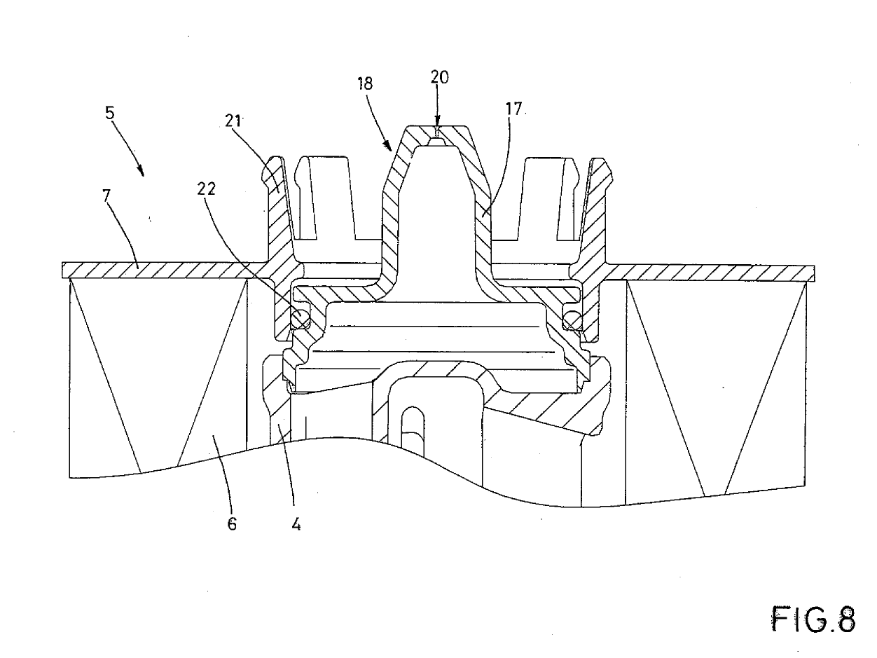

FIG. 8 shows an embodiment that has cap 18 mounted on a support tower 4, which is provided with an inexpensive O-ring seal 22. Unlike the seal 16 that fits against the connecting piece 17 of the cap 18 and is replaced together with the filter insert 5 (see FIGS. 1 and 3), the O-ring seal 22 remains on the cap 18 as a fixed component on the filter.

FIG. 9 shows an example of an embodiment that allows the most inexpensive construction of the liquid filter 1. Placing the upper end plate 7 directly against the cap 18 creates a direct seal 30, which eliminates the necessity of any additional sealing materials. The direct seal 30 extends radially as far as possible on the outer edge of the cap 18, thereby providing the largest possible surface on which particles can land while the filter is being changed. This surface is on the unfiltered side of the liquid filter 1.

FIG. 10 shows a cap 18 for an oil filter that has a filter bypass valve 23 as its functional component: A valve 24 closes a valve opening 25 assembled inside the connecting piece 17. When appropriate pressure is applied to the unfiltered side of the oil filter, the valve 24 is pressed down against the spring force of a spring 26 and uncovers the valve opening 25. The spring pushes thereby against by a spring base 27, which is pressed into the bottom or collar of the cap 18, and preferably fixedly affixed to the cap 18, for example, is welded to the cap. This spring base 27 itself has a second valve opening 28, so that sufficiently high pressure creates a short-circuit between the unfiltered and filtered sides of the oil filter, thus ensuring that an emergency supply of unfiltered oil is provided to the lubricating points.

The arrangement of the filter bypass valve in the cap 18 enables problem-free assembly of the filter bypass valve, since complete access to all assembly sites is provided. The cap 18 with the filter bypass valve can be easily and fixedly attached to the support tower 4, similar to the caps 18 of the other embodiments. In contrast, mounting a filter bypass valve onto the upper end of the support tower would be much more complicated. If the support tower formed the valve opening 25 on its upper end then the assembly including the valve unit 24, the springs 26, and the spring base 27 would have to be extend through the entire length of the support tower to its upper end. Instead, as shown in FIG. 10, the cap 18 of an oil filter may be constructed similarly to one of the caps in FIG. 6-9. The caps 18 differ from one another particularly in that, the cap for an oil filter has a filter bypass valve, whereas the cap of a fuel filter has a vent.

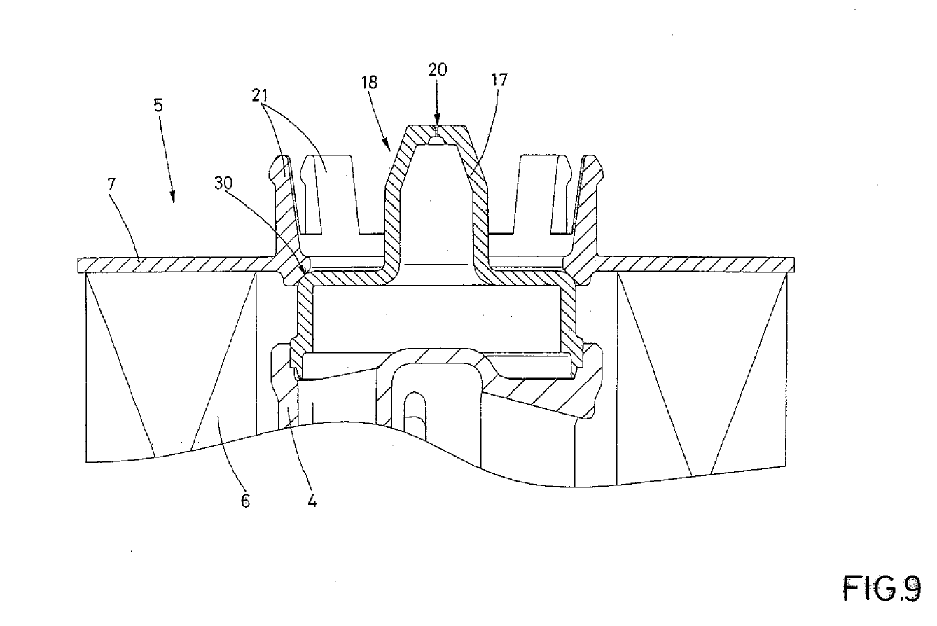

FIG. 11 shows a filter insert 5 that is constructed similarly to the aforementioned embodiments. The wiping lip 11 on its lower end, however, is made of a porous material and is, therefore, compressible, and can thus extend radially much farther inward than the lower seal 15. Due to the compressibility of the wiping lip 11, the lip is also capable of following follow non-ideal or irregular cylindrical surfaces of a support tower 4, when the filter insert 5 is pushed onto the support tower 4. This enables reliable cleaning of the outer surface area of the support tower 4.

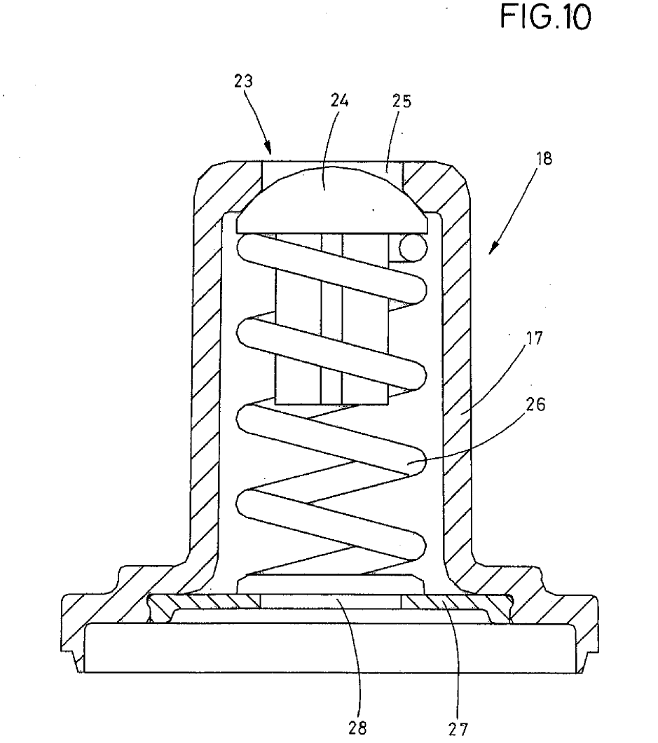

FIG. 12 shows a support tower 4 that does not have an ideal cylindrical surface, but, in terms of the current invention, may still be considered to have a smooth wall: The surface of the support tower 4 has a number of softly rounded protrusions 31. Since these protrusions 31 do not present a sudden cross-sectional change, the wiping lip 11 can easily follow a filter insert 5 over the wavy surface profile of the support tower 4 and permanently contact or fit up against the surface, while the filter insert 5 is being pushed onto the support tower 4.

The spaces between the protrusions 31 provide flow paths 32 for the filtered liquid. This ensures that, even if the filter medium 6 should sit tightly against the protrusions 31 of the support tower 4, the filtered liquid, which is flows radially within the filter medium 6, can still flow along the flow paths 32 to the passage openings 10.

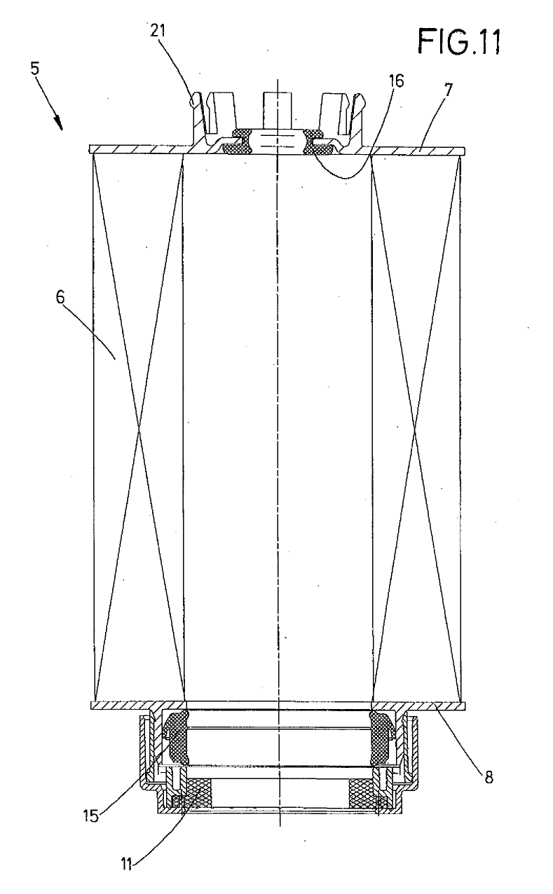

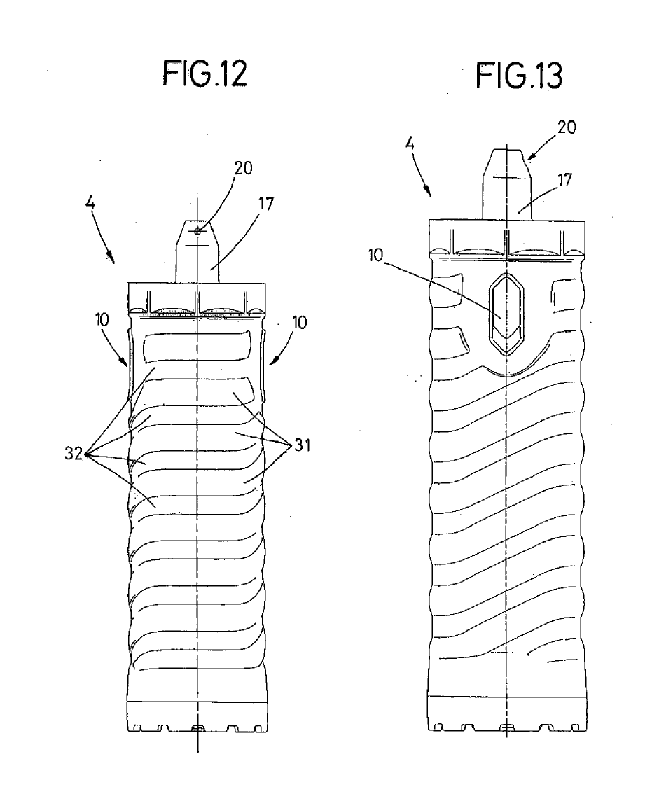

FIG. 13 is a perspective view of the support tower 4, offset ca. 90 degrees. A passage opening 10 is visible, as is the coil-like path of the protrusions 31 and the flow paths 32.

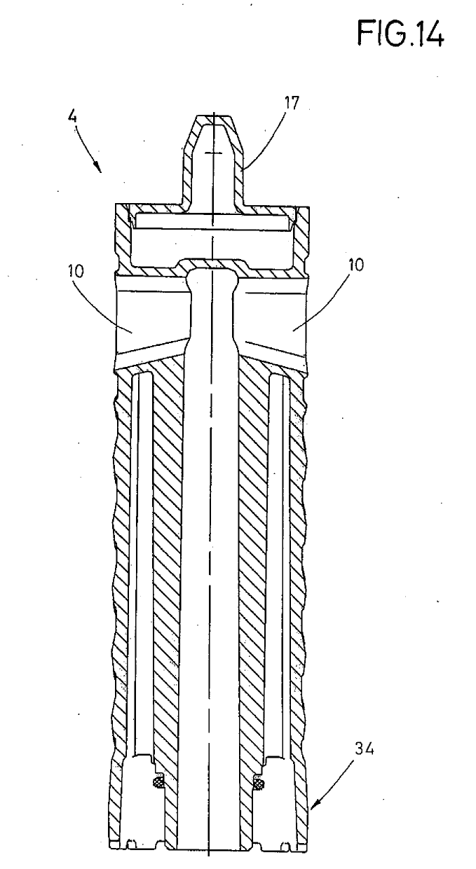

FIG. 14 shows a cross-sectional vertical cut through of the support tower 4. The wavy surface in the cross-sectional is visible, as is the connection that is created by the passage openings 10 between the outer surface of the support tower 4 and its inner space.

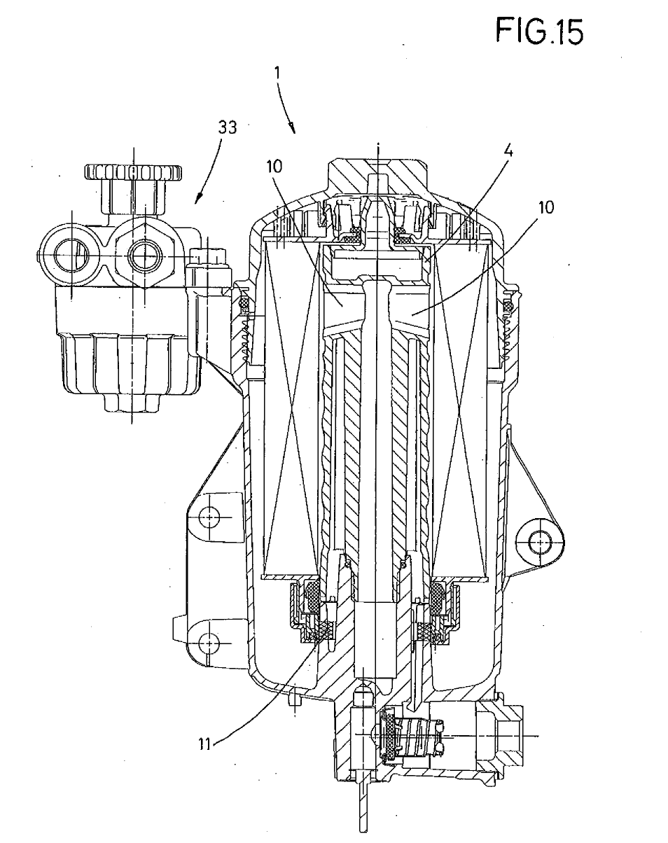

FIG. 15 is an assembly drawing that essentially corresponds to the view of the embodiment in FIG. 1. For the purpose of clarity, many of the reference numbers used in FIG. 1 are not shown in FIG. 15. The main difference in the embodiments in FIGS. 1 and 15 relates to the construction of the support tower 4, which, as shown in FIG. 15, has the same wavy surface that is shown in FIGS. 11 to 14, and also to the construction of the wiping lip 11, which, as is shown in the embodiment in FIG. 15, is made of a compressible material, such as foam, as is illustrated in FIG. 11. The embodiment in FIG. 15 is a fuel filter. A hand feed pump 33 is shown in the upper left, next to the actual liquid filter 1.

The illustrations in the FIGS. 12-15 show that the support tower 4 has a so-called seal area 34 close to its lower end. The diameter of the support tower 4 is slightly larger in this area than in the remaining portion of the support tower 4. This expansion of the diameter serves to protect the seal 15 from wear when the filter insert 5 is being pushed onto the support tower 4. Moreover, the expanded diameter ensures an optimal contact pressure for the seal 15, when the filter insert 5 is brought to its final, assembled position on the support tower 4.

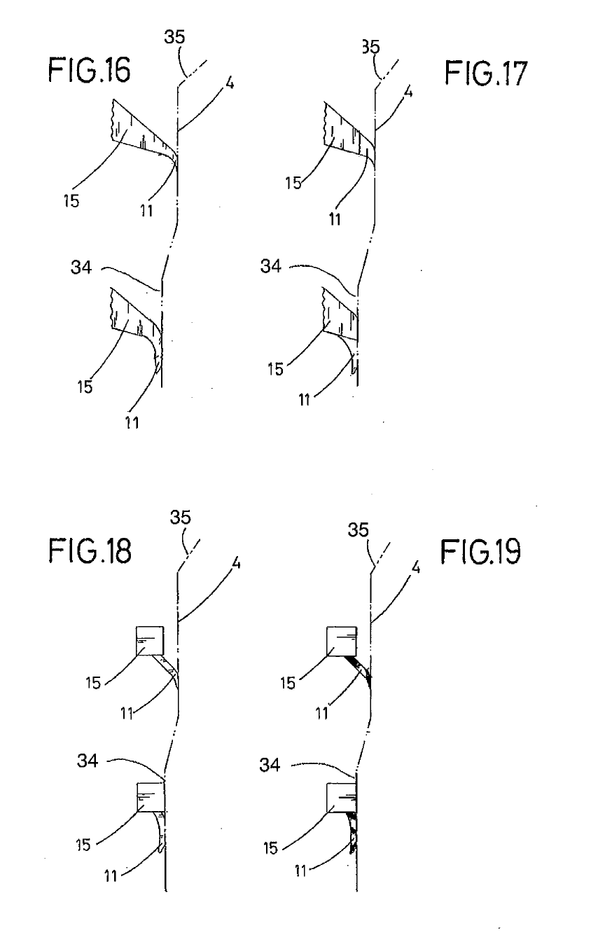

FIGS. 16-19 each illustrate schematically a combination component, which forms the wiping lip 11, as well as the seal 15. In these illustrations, only one side of the support tower 4 is shown, with dot-dash lines. Only a shortened portion of the body of the corresponding support tower 4 is shown. The support tower 4 has an upper end with a first external diameter, which is a relatively small diameter, and has at its lower end a seal area 34 with a second external diameter, which is relatively large diameter. An insertion slant 35 at the upper end tapers inward slightly from the first external diameter. The combination component is found on the filter insert 5 (the insert itself is not shown). The wiping lip 11 is oriented diagonally downward. The insertion slant 35 on the support tower 4 ensures that the wiping lip 11 is not bent upward when the filter insert 5 is placed on the support tower 4, but, rather, that the lip is kept pressed outward and always pointing downward.

The combination component is pushed onto the seal area 34 when the filter insert 5 is inserted to its final assembled position on the support tower 4. The larger diameter in the seal area 34 results in the wiping lip 11 being pressed outward even more, so that the seal 15 fits up against the support tower 4 in this seal area 34. Both of these two different assembly positions of the combination component are shown in each of the FIGS. 16-19.

FIGS. 16 and 18 show embodiments in which the combination component is made of the same material throughout. The combination component here has a relatively small cross-section in the area of the wiping lip 11, thereby providing a lip that is particularly flexible and deformable, compared to the seal 15.

FIGS. 17 and 19, on the other hand, show embodiments in which the combination component is constructed of two different materials, which can be produced as a so-called 2-K component, that is, as an injection molded component, by which the two different materials are injected into the mold cavity at the same time.

1-22. (canceled)

23. A liquid filter of an internal combustion engine, said liquid filter comprising:
a filter housing surrounding an interior space;
a removable cap for closing said filter housing;
an exchangeable filter insert that is insertable into said housing, said exchangeable filter insert having a ring-shaped cross-section and a filter medium for filtering liquid; and
a support tower fixedly arranged in said housing, said support tower extending into said interior space of said housing, so as to prevent said filter medium of said exchangeable filter insert from collapsing;
wherein said interior space includes an unfiltered space and a filtered space and said filter medium provides a barrier between said unfiltered space and said filtered space;
wherein said housing allows flow of liquid from said unfiltered space to said filtered space;
wherein said exchangeable filter insert has a lower end that projects deepest into said housing;
wherein a support-tower seal is disposed near said lower end, said support-tower seal extending radially inward so as to provide a seal against said support tower when said exchangeable filter insert is assembled on said support tower;
wherein a wiping lip is provided below said support-tower seal, said wiping lip dimensioned so as to fit up against said support tower when said exchangeable filter insert is assembled on said support tower; and
wherein said support tower is constructed essentially as a cylindrical tube having a smooth outer wall, such that said wiping lip wipes a circumference of said cylindrical tube when said exchangeable filter insert is assembled on said support tower.

24. The liquid filter of claim 23, wherein said support tower has an outside and an inside, wherein said smooth outer wall of said support tower has an external surface profile that includes protrusions and recesses, wherein said external surface profile forms flow paths along said recesses between said protrusions, said flow paths running to a passage opening in said support tower, and wherein said passage opening provides a flowpath from said outside to said inside of said support tower.

25. The liquid filter of claim 23, wherein said cylindrical tube of said support tower has a first external diameter and also has a lower area having a second external diameter that is greater than said first external diameter, such that said support-tower seal sealingly fits up against said second external diameter of said support tower when said filter is assembled on said support tower.

26. A filter insert for use with a liquid filter having a support tower, said filter insert comprising:
an upper end, a lower end that includes a lower endplate, and a filter medium disposed said upper und and said lower endplate;
wherein a support-tower seal and a wiping lip are disposed at said lower end, such that said wiping lip wipes along a circumference of said support tower when said filter insert is being installed on said support tower and wherein said support-tower seal sealingly fits up against a lower end of said support tower when said filter insert is installed.

27. The filter insert of claim 26, wherein said wiping lip is arranged on said lower endplate of said filter.

28. The filter insert of claim 27, wherein said wiping lip is formed as an extension of said lower endplate, said lower endplate being made from a lower-endplate material, and wherein said wiping lip is also made of said lower-endplate material.

29. The filter insert of claim 28, wherein said wiping lip is made of an elastomeric material.

30. The filter insert of claim 28, wherein said wiping lip is made of a foam material.

31. The filter insert of claim 26, wherein said lower end of said filter insert includes a retainer that is affixed to said lower endplate and wherein said wiping lip is arranged on said retainer.

32. The filter insert of claim 26, wherein said support tower has an essentially cylindrical shape with an upper area and a lower area, wherein said upper area has a first external diameter and said lower area has a second external diameter that is greater than said first external diameter, and wherein said support-tower seal extends radially inward so as to sealingly fit up against said second external circumference of said support tower.

33. The filter insert of claim 26, wherein said support-tower seal extends radially inward toward said support tower a first distance, so as to provide a seal against said circumference of said support tower, and wherein said wiping lip extends radially inward a second distance that is greater than said first distance.

34. The filter insert of claim 26, wherein said wiping lip and said support-tower seal form a combination seal component.

35. The filter insert of claim 34, wherein said wiping lip is made of a first material and said support-tower seal is made of a second material, and wherein said first material is different from said second material.

36. The filter insert of claim 34, wherein said combination seal component is formed as a two-component injection-molded component.

37. A liquid filter of an internal combustion engine, said liquid filter comprising:
a housing surrounding a central interior space that includes an unfiltered interior space and a filtered interior space, said housing providing a flowpath for liquid to flow into and out of said housing;
a removable lid for closing said housing;
an exchangeable filter insert that is insertable in said housing, said exchangeable filter insert having a ring-shaped cross-section and including a filter medium for filtering liquid, said exchangeable filter insert having an upper end with an upper endplate that extends a least possible distance into said housing, and a lower end with a lower endplate, wherein said filter medium provides a barrier between said unfiltered interior space and said filtered interior space;
a support tower extending into said central interior space of said housing, said support tower supporting said exchangeable filter insert, so as to prevent said filter medium of said filter insert from collapsing during filter operation, wherein said support tower is fixedly assembled in said housing;
wherein said support tower has passage openings that enable liquid to flow into said support tower;
wherein said support tower has a tubular body;
wherein, when said exchangeable filter insert is assembled on said support tower, said lower endplate provides a seal against said support tower and said upper endplate provides a seal against said tubular body that is opened only during filter change.

38. The liquid filter of claim 37, wherein said upper endplate is directly sealed against said tubular body of said support tower by placing a seal between said upper endplate and said tubular body.

39. The liquid filter of claim 37, wherein said upper endplate indirectly seals against said tubular body of said support tower by means of an intermediate component that is disposed between said upper endplate and said tubular body, wherein said intermediate component is sealingly connected with said upper endplate, and wherein a seal sealingly fits up against said intermediate component.

40. The liquid filter of claim 37, wherein said upper endplate indirectly seals against said tubular body of said support tower by means of an intermediate component that is disposed between said upper endplate and said tubular body, wherein said intermediate component is tightly affixed with said tubular body, and wherein a seal fits up against said intermediate component.

41. The liquid filter of claim 37, wherein said upper end of said support tower is covered by a cap that includes a functional component.

42. The liquid filter of claim 41, said liquid filter for use as a fuel filter, wherein said functional component is a vent.

43. The liquid filter of claim 41, said liquid filter for use an oil filter, wherein said functional component is a filter bypass valve, which opens when a pressure prevailing on said unfiltered side of said liquid filter exceeds a preset pressure value, and wherein said open bypass valve creates a flowpath from said unfiltered side to said filtered side of said liquid filter.

44. The liquid filter of claim 41, wherein said cap is an integral part of said upper endplate.

45. The liquid filter of claim 41, wherein said cap is a component that is arranged in said upper end of said tubular body of said support tower.

46. The liquid filter of claim 37 for use as a fuel filter in a device that has a fuel tank, said liquid filter further comprising a fuel tank return channel that provides a flowpath for returning fuel to said fuel tank.
